(19) United States
(12) Patent Application Publication
(10) Pub. No.: US 2026/0228581 A1
(43) Pub. Date: Aug. 6, 2026

(54) FOUNDATION MODEL EVALUATION USING SYNTHETIC DATA

(71) Applicant: INTERNATIONAL BUSINESS MACHINES CORPORATION, ARMONK, NY (US)

(72) Inventors: Pin-Yu Chen, White Plains, NY (US); Payel Das, YORKTOWN HEIGHTS, NY (US); Ching-Yun Ko, Cambridge, MA (US)

(21) Appl. No.: 19/043,720

(22) Filed: Feb. 3, 2025

(51) Int. Cl. G06N 7/01

(52) U.S. Cl. CPC G06N 7/01

(57) ABSTRACT

A method, computer program product, and computer system for evaluating foundation models. Synthetic data is generated for binary classification for a downstream task, by random sampling of a mixture of two Gaussian probability distributions. The synthetic data is classified into two classes. Multiple trained foundation models are executed using the synthetic data as input, resulting in each model outputting features data corresponding to features of the synthetic data and classifying the features data using a ϵ-robust Bayes optimal classifier, where e denotes robustness. A ratio of area under the curve of E(a)/E(θₘ, ε, a) is computed for each model of the multiple models, where a denotes accuracy of the classified randomly sampled data, E(a) is an expected scaled bound of the classified randomly sampled data, and E(θₘ, ε, a) is an accuracy-constrained expected bound of the features data. The model having the largest ratio is selected.

### BACKGROUND

The present invention relates to evaluation of foundation models, and more specifically to evaluation of foundation models using synthetic data.

### SUMMARY

Embodiments of the present invention provide a method, a computer program product, and a computer system, for evaluating foundation models.

Synthetic data is generated for binary classification for a downstream task characterized by d independent variables, by randomly sampling data from a mixture Gaussian k (G(y\tilde{μ}ₖ, Σₖ)) (k=1, . . . , K) of (i) a first d-dimensional Gaussian probability density function (PDF) specific to a first class characterized by y=+1 and having a mean of μ₁ₖ and a covariance of Σₖ and (ii) a second d-dimensional Gaussian PDF specific to a second class characterized by y=−1 and having a mean of μ₂ₖ and a covariance of Σₖ, wherein \tilde{μ}ₖ=(μ₁ₖ−μ₂ₖ)/2, and wherein d≥1 and K≥2.

The randomly sampled data is classified, using a Bayes optimal classifier, into the first class and the second class

M trained foundation models are executed using the synthetic data as input and applying an ϵ-robust Bayes optimal classifier, resulting in foundation model m outputting features data corresponding to features of the synthetic data and classifying the features data using the ϵ-robust Bayes optimal classifier, wherein each foundation model m is characterized by model parameters θₘ(m=1, . . . , M), wherein e is an inputted robustness, and wherein M≥2.

An expected scaled bound E(a) of the classified randomly sampled data is computed as a function of an accuracy (a) of the classified randomly sampled data, each accuracy (a) being at least an inputted threshold accuracy (at).

Rₘ is computed according to

$${R}_{m} = {\int }_{{a}_{t}}^{1} E ( {θ}_{m} , ϵ , a ) da / {\int }_{{a}_{t}}^{1} E ( a ) d a$$

for each model m (m=1, . . . , M).

The model number m* is selected according to m*=argmax (Rₘ) for m ε (1, . . . , M).

### BRIEF DESCRIPTION OF THE DRAWINGS

FIG. 1 is a plot of synthetic data randomly sampled from d-dimensional Gaussian probability density functions (PDFs) for binary classification, in accordance with embodiments of the present invention.

FIG. 2 is a plot of output of feature vectors from execution of a pretrained foundation model using the synthetic data of FIG. 1 as input, in accordance with embodiments of the present invention.

FIG. 3 is a plot of expected scaled bound on corrected samples versus accuracy of the classified randomly sampled synthetic data, in accordance with embodiments of the present invention.

FIG. 4 is a flow chart describing a method for evaluating foundation models, in accordance with embodiments of the present invention.

FIG. 5 depict graphs illustrating the ratio area under the curve for ε=0 and ε=0.6, respectively, where & denotes robustness, in accordance with embodiments of the present invention.

FIG. 6A is a flow chart of an embodiment of a process that describes a step of FIG. 4 for generating the synthetic data, in accordance with embodiments of the present invention.

FIG. 6B is a flow chart of an embodiment of a process that describes a step of FIG. 6A for computing a mean and a covariance, in accordance with embodiments of the present invention.

FIG. 7 is a flow chart describing an embodiment of a process for computing an accuracy (a) of the classified randomly sampled data, an expected scaled bound of the classified randomly sampled data as a function of an accuracy (a), and an accuracy-constrained expected bound of the features data as a function of the accuracy (a), in accordance with embodiments of the present invention.

FIG. 8 illustrates a computer system, in accordance with embodiments of the present invention.

FIG. 9 depicts a computing environment which contains an example of an environment for the execution of at least some of the computer code involved in performing the inventive methods, in accordance with embodiments of the present invention.

### DETAILED DESCRIPTION

In recent years, the use of large pretrained neural networks for efficient fine-tuning on downstream tasks has prevailed in many domains such as vision, language, and speech. Instead of designing task-dependent neural network architectures for different downstream tasks, the current methodology focuses on the principle of task-agnostic pretraining and task-specific finetuning. The current methodology uses a neural network pretrained on a large-scale broad dataset to extract generic representations of the input data, which are denoted as pretrained representations for simplicity. The pretrained representations are then used as a foundation (to solve downstream tasks. Prevalent ways include training a linear head (i.e., linear probing) on the representations with the labels provided by a downstream dataset, or simply employing zero-shot inference.

When gauging the usefulness of a pretrained model, it is a convention to conduct evaluations on selected public datasets. However, this convention has several drawbacks. For example, the evaluation process poses significant computational overhead on the model trainer and raises data privacy concerns, setting a high bar for new model designs and large-scale artificial intelligence (AI) governance. More importantly, the evaluation result is dependent on specific evaluation datasets. In addition, the nominal evaluation score can be inconclusive if the evaluation data are biased or under-representative.

Fundamentally, a poor probing result from use of the current methodology might come from either (1) evaluation data bias, (2) true model deficiency, or both.

Embodiments of the present invention attempt to disentangle the effect of valuation data bias and true model deficiency and focus on designing well-posed sanity checks for the true model deficiency. Synthetic data generated from class-conditional data prior, whose optimal classification strategy is known, is utilized and the optimal strategy is compared with representations' linear separability. If the data can be separated with 90% accuracy in the raw input space and 60% in the representation space, then the pretrained model has an intrinsic deficiency. Building on that, the trending practice of pre-training and fine-tuning also signifies immediate damage to all adapted applications if the foundation model has hidden risks such as lacking robustness to adversarial examples. Embodiments of the present invention can evaluate the robustness of pretrained models by considering the same synthetic conditional Gaussian data prior.

An ideal pretrained model should entail both good accuracy and robustness, and the level of goodness is desired to be measurable in a task/data-agnostic manner. Embodiments of the present invention addresses this requirement by establishing a theoretical reference characterizing the robustness-accuracy trade-off of the synthetic data based on the Bayes optimal linear classifiers. Then, the representations of the same synthetic data are obtained from the pretrained model and are compared to the reference. The ratio of area-under the—curves in robustness-accuracy plots is a quantifiable metric of the pretrained representation quality.

Embodiments of the present invention provide, inter alia, the following advantages.

A first advantage provided by embodiments of the present invention is a fundamental trade-off in robustness and accuracy of the considered conditional Gaussian model and usage of this trade-off as a reference to analyze the quality of pretrained representations in a completely real-data-free scenario.

A second advantage provided by embodiments of the present invention is that the pretraining of large models is independent of the downstream datasets and tasks (e.g., through self-supervised or unsupervised training on broad data at scale), so that the inventive use of synthetic data by embodiments of the present invention provides a task-agnostic approach to evaluating pretrained representations.

A third advantage provided by embodiments of the present invention is that the flexibility of generating synthetic data (e.g., by adopting a different data sampling procedure) offers a good proxy towards a more comprehensive evaluation of pretrained representations before fine-tuning on downstream datasets, especially in the scenario when the available datasets are not representative of the entire downstream datasets. Moreover, the use of synthetic data enables complete control and simulation over data size and distribution, protects data privacy, and facilitates model auditing and governance.

Embodiments of the present invention provide a novel and unobvious evaluation framework for pretrained image models that use data synthesized from a data prior. The evaluation process is independent of the downstream image classification datasets/tasks.

Evaluated with several pretrained image models for image classification, experimental results show that performance using embodiments of the present invention matches well the model performance when finetuned on several downstream datasets.

Embodiments of the present invention can be used to guide hyperparameter selection in robust linear probing to mitigate the robustness-accuracy trade-off when fine-tuned on downstream datasets.

To enable quantifying representation quality in the pretraining stage, embodiments of the present invention do not need knowledge of any real-world downstream data and have full control of the evaluation set via synthetic data generation. With the assumed synthetic data distribution, embodiments of the present invention theoretically characterize the reference robustness-accuracy tradeoff. Therefore, embodiments of the present invention provide a standardized quality metric with theoretical groundings and evaluate for representations induced by pretrained models at a low cost.

Without the knowledge of the downstream tasks and data, embodiments of the present invention develop a task-agnostic framework to evaluate some fundamental behaviors of the representation network and both inspect and quantify how representation networks preserve the robustness and accuracy enjoyed by the original synthesized data. On the whole, the idealized robustness-accuracy trade-off is measured using synthetic data. By propagating the Gaussian realizations through different representation networks, the robustness-accuracy trade-off can be compared for representations.

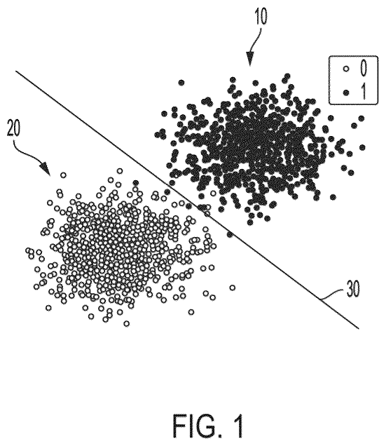

FIG. 1 is a plot of synthetic data randomly sampled from d-dimensional Gaussian probability density functions (PDFs) for binary classification, using a Bayes optimal classifier, for a downstream task characterized by d independent variables, in accordance with embodiments of the present invention. Each synthetic data point in FIG. 1 represents a d-dimensional vector. FIG. 1 is a two-dimensional plot for which d=2.

The synthetic data in FIG. 1 has been classified into a first class 10 having a binary value of 1 and a second class 20 having a binary value of 0, wherein the line 30 separates the synthetic data in the first class 10 from the synthetic data in the second class 20.

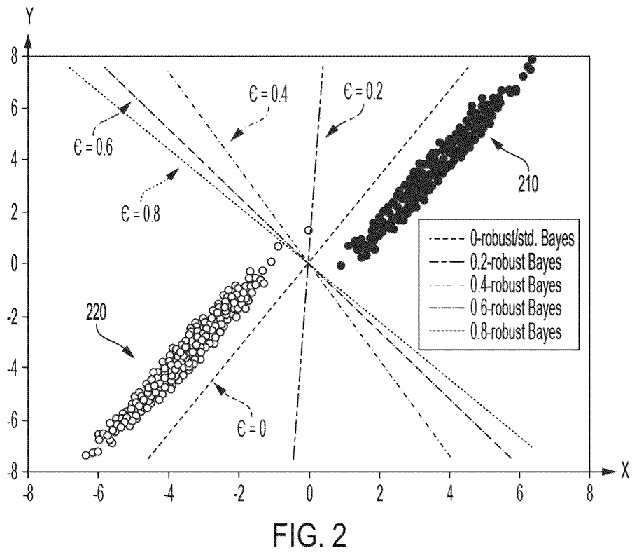

FIG. 2 is a plot of output of feature vectors from execution of a pretrained foundation model using the synthetic data of FIG. 1 as input, in accordance with embodiments of the present invention. The data points in FIG. 2 are the feature vectors that have been classified into classes 210 and 220 which correspond to classes 10 and 20, respectively, in FIG. 1. Each data point in FIG. 2 is a feature vector of dimension J, wherein J is the number of features of the synthetic data analyzed by the foundation model. FIG. depicts two features: a first feature whose values in a range of (−8, 8) are shown on the horizontal axis X and a second feature whose values in a range of (−8, 8) are shown on the vertical axis Y. The feature vectors have been classified, by an ϵ-robust Bayes optimal classifier, into the classes 210 and 220.

The lines ϵ=0, ϵ=0.2, ϵ=0.4, ϵ=0.6, and ϵ=0.8 are decision rules associated with the value of e and correspond to the ϵ-robust Bayes optimal classifier. A decision rule separates the binary classification results. The parameter E, which is an inputted robustness, is a measure of a maximum amount by which an input synthetic data point can be perturbed without the data point's classification being changed.

A foundation model is a pre-trained machine learning model that serves as a general purpose platform for wide variety of downstream tasks and is typically trained on massive data sets across diverse domains and are designed to capture broad patterns, relationships, and knowledge. The foundation models form a foundation upon which more specific models or applications can be built. Examples of foundation models include, inter alia, neural networks, transformers, etc.

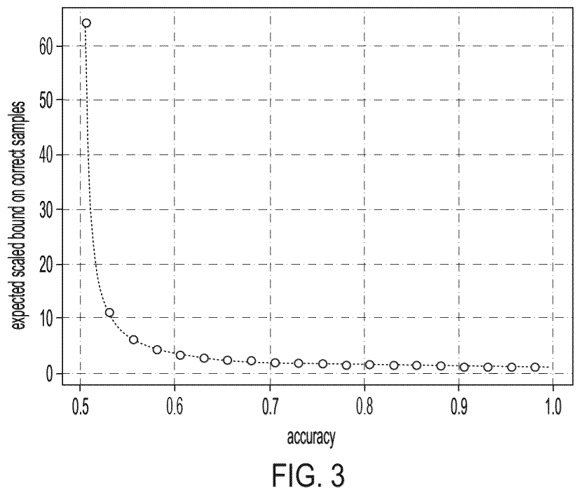

FIG. 3 is a plot of expected scaled bound on corrected samples versus accuracy of the classified randomly sampled synthetic data, in accordance with embodiments of the present invention. The plot in FIG. 3 demonstrates a tradeoff between robustness and accuracy.

Embodiments of the present invention consider binary classification problems for a downstream task characterized by d independent variables with a synthetic data pair (x,y) generated from a mixture Gaussian G(μ₁μ₂,Σ) of two Gaussian distributions G(μ₁,Σ) and G(μ₁, Σ) having respective means μ₁ and μ₂ and a same covariance Σ.

If the two Gaussian distributions are multidimension Gaussian distributions, the mean is a vector whose elements represent the mean of the respective dimension, and the covariance is a matrix whose diagonal elements represent the variance of each dimension and whose off-diagonal elements (i,j) represent the covariance between dimension i and dimension j.

The binary classification has two classes: a first class denoted by y=+1 and a second class denoted by y=−1. Synthetic data for the first class is randomly sampled from G(μ₁,Σ), and synthetic data for the second class is randomly sampled from G(μ₂,Σ). The downstream task is characterized by d independent variables, wherein d≥1.

Equivalently, the synthetic data may be generated by random sampling from the mixture Gaussian as follows. The mixture Gaussian G(μ₁μ₂, Σ) can be expressed as G(y\tilde{μ},Σ), wherein \tilde{μ}=(μ₁−μ₂)/2. The synthetic data point x, which is a d-dimensional vector, for classes of y=+1 and y=−1, is computed via x=½ (μ1+μ₂)|y+xₛ, wherein xₛ is randomly sampled from the mixed Gaussian G(y\tilde{μ}, Σ) whose mean is y\tilde{μ} and whose covariance is Σ.

It is noted that the probability P (y=+1)=τ and the probability P (y=−1)=1−τ. Embodiments of the present invention focus on the class balanced case of τ=½. When sampling from an ideal setting of the class balanced case, the factor of data bias is eliminated and the accuracy and robustness degradation in such an ideal setting can be tested.

For samples drawn from G(μ₁μ₂,Σ) with Σ=σ²I_{d}, all ϵ-robust Bayes optimal classifiers overlap with each other. For a general covariance Σ, the robustness e of an ϵ-robust Bayes optimal classifier specifies the desired size of margin and demonstrates the robustness accuracy trade-off. In the illustrative two-dimensional class conditional Gaussian example in FIG. 2, different ϵ-robust Bayes optimal classifiers give different overall margins at the cost of accuracy. As the robustness ϵ increases, the ϵ-robust Bayes optimal classifiers rotate counterclockwise (AS SHOWN I FIG. 2), leading to increased misclassifications, but also overall enlarged margins.

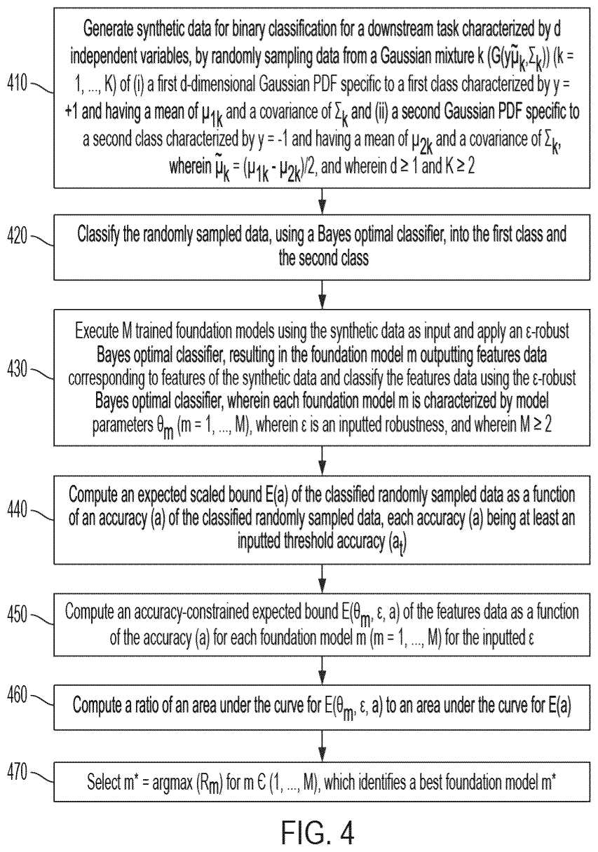

FIG. 4 is a flow chart describing a method for evaluating foundation models, in accordance with embodiments of the present invention. The flow chart of FIG. 4 includes steps 410-470.

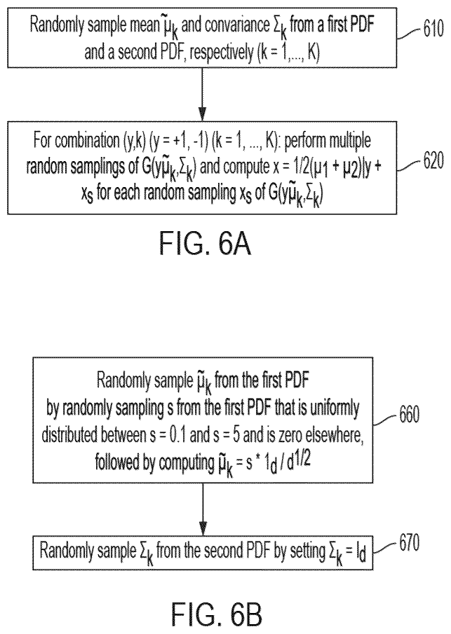

Step 410 generates synthetic data for binary classification for a downstream task characterized by d independent variables, by randomly sampling data from a mixture Gaussian k (G(y\tilde{μ}ₖ, Σₖ)) (k=1, . . . , K) of (i) a first d-dimensional Gaussian probability density function (PDF) specific to a first class characterized by y=+1 and having a mean of μ₁ₖ and a covariance of Σₖ and (ii) a second d-dimensional Gaussian PDF respectively specific to a second class characterized by y=−1 and having a mean of μ₂ₖ and a covariance of Σₖ, wherein \tilde{μ}ₖ=(μ₁ₖ−μ₂ₖ)/2, and wherein d≥1 and K≥2. Step 410 generates the synthetic data in an input space of the d independent variables. An embodiment for describing step 410 in greater detail is presented infra in FIG. 6A.

Step 420 classifies the randomly sampled data, using a Bayes optimal classifier, into the first class and the second class.

Step 430 executes M trained foundation models using the synthetic data as input and applies an ϵ-robust Bayes optimal classifier, resulting in foundation model m outputting features data corresponding to features of the synthetic data and classifying the features data using the ϵ-robust Bayes optimal classifier. Each foundation model m is characterized by model parameters θₘ(m=1, . . . , M). The robustness e may be an input in one embodiment, and M≥2.

Step 430 generates, in a representation space, the features data of J features of the synthetic data, wherein J≥1. The J features may pertain, inter alia, to patterns, relationships, and structures in the synthetic data (e.g., semantic meaning, hierarchical structures, contextual relationships), enabling the foundation model to make predictions, classifications, and/or generate outputs.

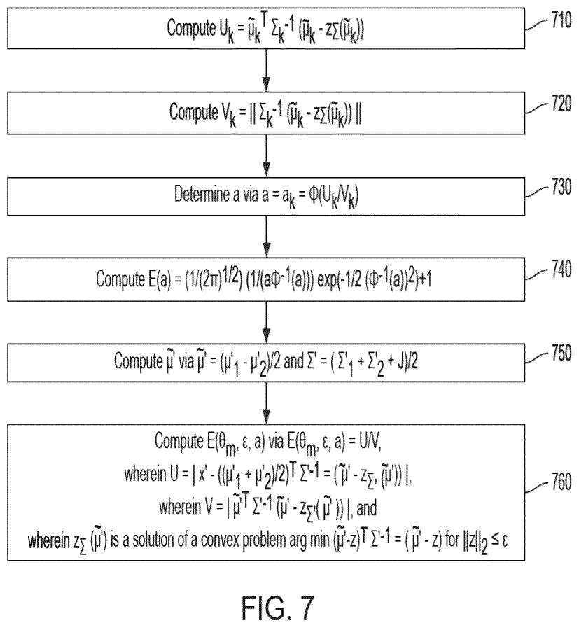

Step 440 computes an expected scaled bound E(a) of the classified randomly sampled data as a function of an accuracy (a) of the classified randomly sampled data. Each accuracy (a) is at least an inputted threshold accuracy (aₜ). An embodiment for computing the accuracy (a) of the classified randomly sampled data is presented infra in FIG. 7.

Step 450 computes an accuracy-constrained expected bound E(θₘ, ε, a) of the features data as a function of the accuracy (a) for each foundation model m (m=1, . . . , M) for the inputted €. Generally, E(θₘ, ε, a)≤E(a). If E(θₘ, ε, a)=E(a), then there is no degradation in the features data caused by execution of the foundation model m relative to the classified randomly sampled data. If E(θₘ, ε, a)<E(a), then there is degradation in the features data caused by execution of the foundation model m relative to the classified randomly sampled data.

Step 460 computes

$${R}_{m} = {\int }_{{a}_{t}}^{1} E ( {θ}_{m} , ϵ , a ) da / {\int }_{{a}_{t}}^{1} E ( a ) da$$

for each foundation model m

(m=1, . . . , M).

$${\int }_{{a}_{t}}^{1} E ( {θ}_{m} , ϵ , a ) da$$

is the area under the curve of E(θₘ, ε, a) from a=aₜ to a=1.

$${\int }_{{a}_{t}}^{1} E ( a ) d a$$

is the area under the curve of E(a) from a=aₜ to a=1.

The ratio area under the curve (RAUC) Rₘ is a measure of non-degradation of the features data caused by execution of the foundation model m relative to the classified randomly sampled data. Thus, for any two foundation models m1 and m2, the foundation model is better than foundation model m1 if Rₘ₂>Rₘ₁, because m2 causes less degradation than does foundation model m1. Accordingly, the foundation model m* ∈(1, . . . , M) is the best foundation model of the M foundation models if foundation model m* has the highest RAUC among the M foundation models.

Step 470 selects m*=argmax (Rₘ) for m ∈ (1, . . . , M), which identifies a best foundation model m* of the M foundation models.

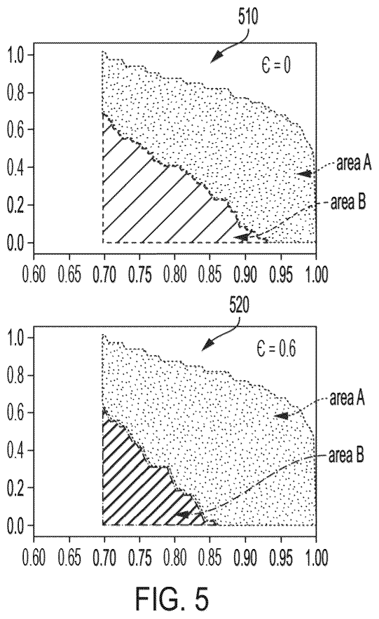

FIG. 5 depict graphs 510 and 520 illustrating the ratio area under the curve (RAUC) for ε=0 and ε=0.6, respectively, in accordance with embodiments of the present invention.

In graphs 510 and 520, RAUC=Area B/(Area A+Area B), wherein Area

$$B = {\int }_{{a}_{t}}^{1} E ( {θ}_{m} , ϵ , a ) da and ( Area A + Area B ) = {\int }_{{a}_{t}}^{1} E ( a ) d a .$$

The RAUC for graph 520 with ε=0.6 is less than the RAUC for graph 510 with ε=0, which confirms the tradeoff between robustness and accuracy depicted in FIG. 3 (i.e., the higher the robustness ε, the lower the accuracy a).

FIG. 6A is a flow chart of an embodiment of a process that describes step 410 of FIG. 4 for generating the synthetic data, in accordance with embodiments of the present invention.

The flow chart of FIG. 6A includes steps 610-620.

It is noted that the synthetic data are d-dimensional vectors x.

Step 610 randomly samples mean \tilde{μ}ₖ and covariance Σₖ from a first PDF and a second PDF, respectively (k=1, . . . , K), in accordance with embodiments of the present invention. An embodiment for implementing step 610 is presented infra in FIG. 6B.

In step 620, for each combination (y,k) (y=+1,−1) (k=1, . . . , K), the process: performs multiple random samplings of G(y\tilde{μ}ₖ, μₖ) and computes x=½ (\tilde{μ}₁+\tilde{μ}₂)|y+xₛ for each random sampling xₛ of G(y\tilde{μ}ₖ, Σₖ).

FIG. 6B is a flow chart of an embodiment of a process that describes step 610 of FIG. 6A for computing mean \tilde{μ}ₖ and covariance Σₖ, in accordance with embodiments of the present invention. The flow chart of FIG. 6B includes steps 660-670.

In step 660, randomly sampling \tilde{μ}ₖ from the first PDF comprises randomly sampling s from the first PDF that is uniformly distributed between s=0.1 and s=5 and is zero elsewhere, followed by computing \tilde{μ}ₖ=s* I_{d}/d^{1/2}, wherein 1_{d} is a d-dimensional vector all of whose elements are 1.

In step 670, randomly sampling Σₖ from the second PDF comprises setting Σₖ=I_{d}, wherein I_{d} is a d-dimensional unit matrix.

FIG. 7 is a flow chart describing an embodiment of a process for computing the accuracy (a) of the classified randomly sampled data, the expected scaled bound E(a) of the classified randomly sampled data as a function of an accuracy (a), and the accuracy-constrained expected bound E(θₘ, ε, a) of the features data as a function of the accuracy (a) in steps 430, 440, and 450, respectively, of FIG. 4, in accordance with embodiments of the present invention.

The flow chart of FIG. 7 includes steps 710-760.

Steps 710-730 compute the accuracy (a) for each (\tilde{μ}ₖ, Σₖ) (k=1, . . . , K) via a=aₖ=Φ(Uₖ/Vₖ), wherein Φ denotes a cumulative density function (CDF) of the standard normal distribution.

Step 710 computes Uₖ=\tilde{μ}ₖ^{T}Σₖ⁻¹(ãₖ−z_{Σ}(\tilde{μ}ₖ)).

Step 720 computes Vₖ=|Σₖ⁻¹(\tilde{μ}ₖ−z_{Σ}(\tilde{μ}ₖ))|.

It is noted that z_{Σ}(\tilde{μ}ₖ) is a solution of a convex problem argmin (\tilde{μ}ₖ−z)^{T}Σₖ⁻¹(\tilde{μ}ₖ−z) for |z|₂≤ϵ.

Step 730 determines a via a=aₖ=Φ(Uₖ/Vₖ).

Step 740 computes the expected scaled bound E(a) via Equation (1).

$$E ( a ) = ( 1 / \sqrt{2 π} ) ( 1 / ( a {Φ}^{- 1} ( a ) ) ) exp ( - 1 / 2 {( {Φ}^{- 1} ( a ) )}^{2} ) + 1 \qquad ( 1 )$$

Steps 750-760 compute the accuracy-constrained expected bound E(θₘ, ε, a).

The features data comprise multiple J-dimensional feature vectors x′ having a mean u′₁ and a covariance Σ′₁ for the first class and a mean μ′₂ and a covariance Σ′₂ for the second class, wherein J≥2.

Step 750 computes \tilde{μ} ′ via \tilde{μ}′=(μ′₁−μ′₂)/2 and Σ′=(Σ′₁+Σ′₂+J)/2.

Step 760 computes E(θₘ, ε, a) via E(θₘ, ε, a)=U/V, wherein U=|(x′−((μ′₁+μ′₂)/2)^{T}Σ′⁻¹(\tilde{μ}′−z_{Σ′}(\tilde{μ}′))|, wherein V=|\tilde{μ}^{T}Σ′⁻¹(\tilde{μ}′−z_{Σ′}(\tilde{μ}′))| and wherein z_{Σ′}(\tilde{μ}′) is a solution of a convex problem argmin (\tilde{μ}′−z)^{T}Σ′⁻¹(\tilde{μ}′−z) for |z|₂≤ϵ.

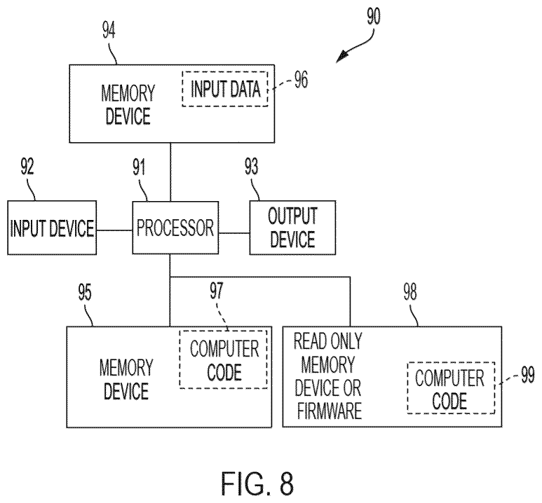

FIG. 8 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 8 shows the computer system 90 as a particular configuration of hardware and software, any configuration of hardware and software, as would be known to a person of ordinary skill in the art, may be utilized for the purposes stated supra in conjunction with the particular computer system 90 of FIG. 8. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

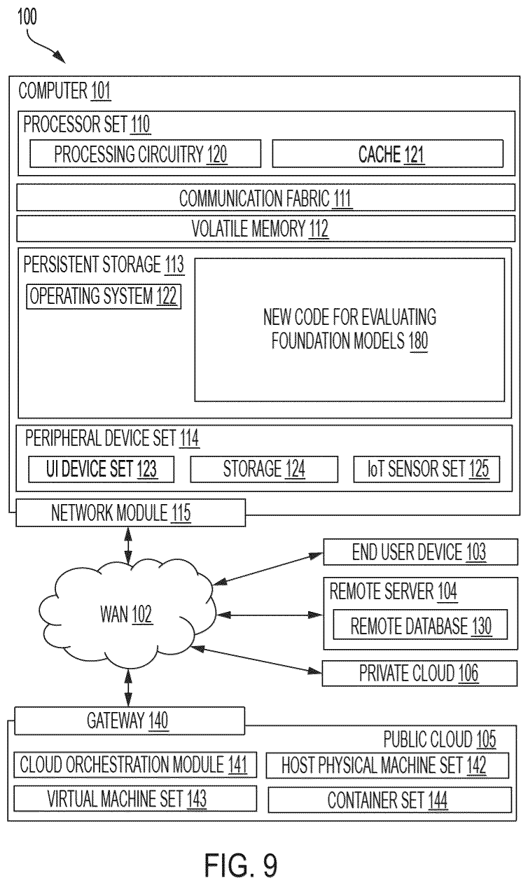

FIG. 9 depicts a computing environment 100 which contains an example of an environment for the execution of at least some of the computer code involved in performing the inventive methods, in accordance with embodiments of the present invention. Such computer code includes new code for evaluating foundation models 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for evaluating foundation models, said method comprising:
generating synthetic data for binary classification for a downstream task characterized by d independent variables, by randomly sampling data from a mixture Gaussian k(G(y\tilde{μ}ₖ, Σₖ))(k=1, . . . , K) of (i) a first d-dimensional Gaussian probability density function (PDF) specific to a first class characterized by y=+1 and having a mean of μ₁ₖ and a covariance of Σₖ and (ii) a second d-dimensional Gaussian PDF specific to a second class characterized by y=−1 and having a mean of μ₂ₖ and a covariance of Σₖ, wherein \tilde{μ}ₖ=(μ₁ₖ−μ₂ₖ)/2, wherein d≥1 and K≥2;
classifying the randomly sampled data, using a Bayes optimal classifier, into the first class and the second class;
executing M trained foundation models using the synthetic data as input and applying an ϵ-robust Bayes optimal classifier, resulting in foundation model m outputting features data corresponding to features of the synthetic data and classifying the features data using the ϵ-robust Bayes optimal classifier, wherein each foundation model m is characterized by model parameters θₘ(m=1, . . . , M), wherein e is an inputted robustness, and wherein M≥2;
computing an expected scaled bound E(a) of the classified randomly sampled data as a function of an accuracy (a) of the classified randomly sampled data, each accuracy (a) being at least an inputted threshold accuracy (aₜ);
computing an accuracy-constrained expected bound E(θₘ, ε, a) of the features data as a function of the accuracy (a) for each foundation model m (m=1, . . . , M) for the inputted e; computing
$${R}_{m} = {\int }_{{a}_{t}}^{1} E ( {θ}_{m} , ϵ , a ) da / {\int }_{{a}_{t}}^{1} E ( a ) da$$
for each model m (m=1, . . . , M);
selecting m*=argmax (Rₘ) for m ∈ (1, . . . , M), which identifies a best foundation model m*.

2. The method of claim 1, wherein the synthetic data are d-dimensional vectors x, and wherein said generating synthetic data comprises:
randomly sampling mean \tilde{μ}ₖ and covariance Σₖ from a first PDF and a second PDF, respectively (k=1, . . . , K);
for each combination (y,k) (y=+1,−1) (k=1, . . . , K): performing multiple random samplings of G(y\tilde{μ}ₖ, Σₖ) and computing x=½ (\tilde{μ}₁+\tilde{μ}₂)|y+xₛ for each random sampling xₛ of G(y\tilde{μ}ₖ, Σₖ).

3. The method of claim 2, wherein said randomly sampling \tilde{μ}ₖ from the first PDF comprises randomly sampling s from the first PDF that is uniformly distributed between s=0.1 and s=5 and is zero elsewhere, followed by computing \tilde{μ}ₖ=s*I_{d}/\sqrt{d}, and wherein said randomly sampling Σₖ from the second PDF comprises setting Σₖ=I_{d}.

4. The method of claim 2, wherein the method comprises:
computing the accuracy (a) for each (\tilde{μ}ₖ, Σₖ) (k=1, K) via a=aₖ=Φ(Uₖ/Vₖ), wherein Uₖ=\tilde{μ}ₖ^{T}Σₖ⁻¹(\tilde{μ}ₖ−zΣ(\tilde{μ}ₖ)), wherein Vₖ=|Σₖ⁻¹(\tilde{μ}ₖ−zΣ(\tilde{μ}ₖ))∥Σ, wherein Z_{Σ}(ãₖ) is a solution of a convex problem argmin (\tilde{μ}ₖ−z)^{T}Σₖ⁻¹(\tilde{μ}ₖ−z) for |z|2≤ϵ, and wherein Φ denotes a cumulative density function (CDF) of a standard normal distribution.

5. The method of claim 4, wherein said computing E(a) is performed according to:
$$E ( a ) = ( 1 / \sqrt{2 π} ) ( 1 / ( a {Φ}^{- 1} ( a ) ) ) exp ( - 1 / 2 {( {Φ}^{- 1} ( a ) )}^{2} ) + 1 .$$

6. The method of claim 4, wherein the features data comprise multiple J-dimensional feature vectors x′ having a mean μ′₁ and a covariance Σ′₁ for the first class and a mean μ′₂ and a covariance Σ′₂ for the second class, wherein J≥2, wherein said computing E(σₘ, ε, a) comprises:
$$computing {\tilde{μ}}^{′} = ( {μ}_{1}^{′} - {μ}_{2}^{′} ) / 2 and {\sum }^{′} = ( {\sum }_{1}^{′} + {\sum }_{2}^{′} + J ) / 2 ; and$$
$$computing E ( {θ}_{m} , ε , a ) = U / V ,$$
$$wherein U = \vert ( {x}^{′} - {( ( {μ}_{1}^{′} - {μ}_{2}^{′} ) / 2 )}^{T} {\sum }^{′ - 1} ( {\tilde{μ}}^{′} - {Z}_{{\sum }^{′}} ( {\tilde{μ}}^{′} ) ) \vert ,$$
wherein V=|\tilde{μ}′^{T}Σ′⁻¹(\tilde{μ}′−z_{Σ′}(\tilde{μ}′))|, and wherein z_{Σ′}(\tilde{μ}′) is a solution of a convex problem argmin (\tilde{μ}′−z)^{T}Σ′⁻¹(\tilde{μ}′−z) for |z|₂≤ϵ.

7. The method of claim 2, wherein Σₖ=I_{d}(k=1, . . . , K).

8. A computer program product, comprising one or more computer readable storage media storing computer readable program instructions, said program instructions executable by one or more processors of a computer system to cause the computer system to perform operations for evaluating foundation models, said operations comprising:
generating synthetic data for binary classification for a downstream task characterized by d independent variables, by randomly sampling data from a mixture Gaussian k (G(y\tilde{μ}ₖ, Σₖ)) (k=1, . . . , K) of (i) a first d-dimensional Gaussian probability density function (PDF) specific to a first class characterized by y=+1 and having a mean of μ₁ₖ and a covariance of Σₖ and (ii) a second d-dimensional Gaussian PDF specific to a second class characterized by y=−1 and having a mean of μ₂ₖ and a covariance of Σₖ, wherein \tilde{μ}ₖ=(μ₁ₖ−μ₂ₖ)/2, wherein d≥1 and K≥2;
classifying the randomly sampled data, using a Bayes optimal classifier, into the first class and the second class;
executing M trained foundation models using the synthetic data as input and applying an ϵ-robust Bayes optimal classifier, resulting in foundation model m outputting features data corresponding to features of the synthetic data and classifying the features data using the ϵ-robust Bayes optimal classifier, wherein each foundation model m is characterized by model parameters θₘ(m=1, . . . , M), wherein e is an inputted robustness, and wherein M≥2;
computing an expected scaled bound E(a) of the classified randomly sampled data as a function of an accuracy (a) of the classified randomly sampled data, each accuracy (a) being aₜ least an inputted threshold accuracy (aₜ);
computing an accuracy-constrained expected bound E(θₘ, ε, a) of the features data as a function of the accuracy (a) for each foundation model m (m=1, . . . , M) for the inputted E;
computing
$${R}_{m} = {\int }_{{a}_{t}}^{1} E ( {θ}_{m} , ϵ , a ) da / {\int }_{{a}_{t}}^{1} E ( a ) da$$
for each model m (m=1, . . . , M);
selecting m*=argmax (Rₘ) for m ε (1, . . . , M), which identifies a best foundation model m *.

9. The computer program product claim 8, wherein the synthetic data are d-dimensional vectors x, and wherein said generating synthetic data comprises:
randomly sampling mean \tilde{μ}ₖ and covariance Σₖ from a first PDF and a second PDF, respectively (k=1, . . . , K);
for each combination (y,k) (y=+1,−1) (k=1, . . . , K): performing multiple random samplings of G(y\tilde{μ}ₖ, μₖ) and computing x=½ (\tilde{μ}₁+\tilde{μ}₂)|y+xₛ for each random sampling xₛ of G (y\tilde{μ}ₖ, Σₖ).

10. The computer program product claim 9, wherein said randomly sampling \tilde{μ}ₖ from the first PDF comprises randomly sampling s from the first PDF that is uniformly distributed between s=0.1 and s=5 and is zero elsewhere, followed by computing \tilde{μ}ₖ=s*1_{d}/\sqrt{d}, and wherein said randomly sampling Σₖ from the second PDF comprises setting Σₖ=I_{d}.

11. The computer program product claim 9, wherein the operations further comprise:
computing the accuracy (a) for each (\tilde{μ}ₖ,Σₖ)(k=1, K) via a=aₖ=Φ(Uₖ/Vₖ), wherein Uₖ=\tilde{μ}ₖ^{T}Σₖ⁻¹(\tilde{μ}ₖ−zΣ(\tilde{μ}ₖ)), wherein Vₖ=|Σₖ⁻¹(\tilde{μ}ₖ−zΣ(\tilde{μ}ₖ))∥Σ, wherein zΣ(\tilde{μ}ₖ) is a solution of a convex problem argmin (\tilde{μ}ₖ−z)^{T}Σₖ⁻¹(\tilde{μ}ₖ−z) for |z|2≤ϵ, and wherein Φ denotes a cumulative density function (CDF) of a standard normal distribution.

12. The computer program product claim 11, wherein said computing E(a) is performed according to:
$$E ( a ) = ( 1 / \sqrt{2 π} ) ( 1 / ( a {Φ}^{- 1} ( a ) ) ) exp ( - 1 / 2 {( {Φ}^{- 1} ( a ) )}^{2} ) + 1 .$$

13. The computer program product claim 11, wherein the features data comprise multiple J-dimensional feature vectors x′ having a mean μ′₁ and a covariance Σ′₁ for the first class and a mean μ′₂ and a covariance Σ′₂ for the second class, wherein J≥2, wherein said computing E(θₘ, ε, a) comprises:
$$computing {\tilde{μ}}^{′} = ( {μ}_{1}^{′} - {μ}_{2}^{′} ) / 2 and {\sum }^{′} = ( {\sum }_{1}^{′} + {\sum }_{2}^{′} + J ) / 2 ; and$$
$$computing E ( {θ}_{m} , ε , a ) = U / V ,$$
$$wherein U = \vert ( {x}^{′} - {( ( {μ}_{1}^{′} - {μ}_{2}^{′} ) / 2 )}^{T} {\sum }^{′ - 1} ( {\tilde{μ}}^{′} - {Z}_{{\sum }^{′}} ( {\tilde{μ}}^{′} ) ) \vert ,$$
wherein V=|\tilde{μ}′^{T}Σ′⁻¹(\tilde{μ}′−z_{Σ′}(\tilde{μ}′))|, and wherein z_{Σ′}(\tilde{μ}′) is a solution of a convex problem argmin (\tilde{μ}′−z)^{T}Σ′⁻¹(\tilde{μ}′−z) for |z|₂≤ϵ.

14. The computer program product claim 9, wherein Σₖ=I_{d}(k=1, . . . , K).

15. A computer system, comprising one or more processors, one or more memories, one or more computer readable storage media, and computer readable program instructions stored on the one or more computer readable storage media for execution by the one or more processors via the one or more memories to cause the computer system to perform operations for evaluating foundation models, said operations comprising:
generating synthetic data for binary classification for a downstream task characterized by d independent variables, by randomly sampling data from a mixture Gaussian k (G(y\tilde{μ}ₖ, μₖ)) (k=1, . . . , K) of (i) a first d-dimensional Gaussian probability density function (PDF) specific to a first class characterized by y=+1 and having a mean of μ₁ₖ and a covariance of Σₖ and (ii) a second d-dimensional Gaussian PDF specific to a second class characterized by y=−1 and having a mean of μ₂ₖ and a covariance of Σₖ, wherein \tilde{μ}ₖ=(μ₁ₖ−μ₂ₖ)/2, wherein d≥1 and K≥2;
classifying the randomly sampled data, using a Bayes optimal classifier, into the first class and the second class;
executing M trained foundation models using the synthetic data as input and applying an ϵ-robust Bayes optimal classifier, resulting in foundation model m outputting features data corresponding to features of the synthetic data and classifying the features data using the ϵ-robust Bayes optimal classifier, wherein each foundation model m is characterized by model parameters θₘ(m=1, . . . , M), wherein e is an inputted robustness, and wherein M≥2;
computing an expected scaled bound E(a) of the classified randomly sampled data as a function of an accuracy (a) of the classified randomly sampled data, each accuracy (a) being aₜ least an inputted threshold accuracy (aₜ);
computing an accuracy-constrained expected bound E(θₘ, ε, a) of the features data as a function of the accuracy (a) for each foundation model m (m=1, . . . , M) for the inputted ϵ; computing
$${R}_{m} = {\int }_{{a}_{t}}^{1} E ( {θ}_{m} , ϵ , a ) da / {\int }_{{a}_{t}}^{1} E ( a ) da$$
for each model m (m=1, . . . , M);
selecting m*=argmax (Rₘ) for m ∈ (1, . . . , M), which identifies a best foundation model m *.

16. The computer system of claim 15, wherein the synthetic data are d-dimensional vectors x, and wherein said generating synthetic data comprises:
randomly sampling mean \tilde{μ}ₖ and covariance Σₖ from a first PDF and a second PDF, respectively (k=1, . . . , K);
for each combination (y,k) (y=+1,−1) (k=1, . . . , K): performing multiple random samplings of G(y\tilde{μ}ₖ, μₖ) and computing x=½ (μ₁+μ₂)|y+xₛ for each random sampling xₛ of G(y\tilde{μ}ₖ, Σₖ).

17. The computer system of claim 16, wherein said randomly sampling \tilde{μ}ₖ from the first PDF comprises randomly sampling s from the first PDF that is uniformly distributed between s=0.1 and s=5 and is zero elsewhere, followed by computing \tilde{μ}ₖ=s*1_{d}/\sqrt{d}, and wherein said randomly sampling Σₖ from the second PDF comprises setting Σₖ=I_{d}.

18. The computer system of claim 16, wherein the operations further comprise:
computing the accuracy (a) for each (\tilde{μ}ₖ, μₖ) (k=1, K) via a=aₖ=Φ(Uₖ/Vₖ), wherein Uₖ=\tilde{μ}ₖ^{T}Σₖ⁻¹(\tilde{μ}ₖ−zΣ(\tilde{μ}ₖ)), wherein Vₖ=|Σₖ⁻¹(\tilde{μ}ₖ−z_{Σ}(\tilde{μ}ₖ))|_{Σ}, wherein z_{Σ}(\tilde{μ}ₖ) is a solution of a convex problem argmin (\tilde{μ}ₖ−z)^{T}Σₖ⁻¹(\tilde{μ}ₖ−z) for |z|₂≤ϵ, and wherein Φ denotes a cumulative density function (CDF) of a standard normal distribution.

19. The computer system of claim 18, wherein said computing E(a) is performed according to:
$$E ( a ) = ( 1 / \sqrt{2 π} ) ( 1 / ( a {Φ}^{- 1} ( a ) ) ) exp ( - 1 / 2 {( {Φ}^{- 1} ( a ) )}^{2} ) + 1 .$$

20. The computer system of claim 18, wherein the features data comprise multiple J-dimensional feature vectors x′ having a mean μ′₁ and a covariance Σ′₁ for the first class and a mean μ′₂ and a covariance Σ′₂ for the second class, wherein J≥2, wherein said computing E(θₘ, ε, a) comprises:
$$computing {\tilde{μ}}^{′} = ( {μ}_{1}^{′} - {μ}_{2}^{′} ) / 2 and {\sum }^{′} = ( {\sum }_{1}^{′} + {\sum }_{2}^{′} + J ) / 2 ; and$$
$$computing E ( {θ}_{m} , ε , a ) = U / V ,$$
$$wherein U = \vert ( {x}^{′} - {( ( {μ}_{1}^{′} - {μ}_{2}^{′} ) / 2 )}^{T} {\sum }^{′ - 1} ( {\tilde{μ}}^{′} - {Z}_{{\sum }^{′}} ( {\tilde{μ}}^{′} ) ) \vert ,$$
wherein V=|\tilde{μ}′^{T}Σ′⁻¹(\tilde{μ}′−z_{Σ}′(\tilde{μ}′))|, and wherein z_{Σ}′(\tilde{μ}′) is a solution of a convex problem argmin (\tilde{μ}′−z)^{T}Σ′⁻¹(\tilde{μ}′−z) for |z|₂≤ϵ.
